(19) United States
(12) Patent Application Publication
(10) Pub. No.: US 2015/0090087 A1
(43) Pub. Date: Apr. 2, 2015

(54) AQUEOUS WIRE SLICING FLUIDS AND RELATED METHODS OF SLICING

(71) Applicant: Saint-Gobain Ceramics & Plastics, Inc., Worcester, MA (US)

(72) Inventors: Jason Alexander Sherlock, Anaheim, CA (US); Douglas E. Ward, Santa Ana, CA (US); Chun Lung Kuan, Cerritos, CA (US)

(21) Appl. No.: 14/497,527

(22) Filed: Sep. 26, 2014

Related U.S. Application Data
(60) Provisional application No. 61/883,350, filed on Sep. 27, 2013.

(51) Int. Cl. C10M 141/10; B28D 5/00; B28D 5/04

(52) U.S. Cl. CPC C10M 141/10; B28D 5/045; B28D 5/0076
USPC 83/22; 508/423; 125/21

(57) ABSTRACT

An aqueous coolant fluid for cutting or machining a semiconductor substrate, comprising at least one organic phosphorous containing acid or salt thereof, at least one polyol; and at least one surfactant, and a method of cutting a silicon ingot or wafer using the coolant fluid.

### CROSS-REFERENCE TO RELATED APPLICATION(S)

This application claims priority under 35 U.S.C. §119(e) to U.S. Patent Application No. 61/883,350 entitled “Aqueous Wire Slicing Fluids and Related Methods of Slicing,” by Jason Alexander Sherlock, Douglas E. Ward, and Chun Lung Kuan, filed Sep. 27, 2014, which is assigned to the current assignee hereof and incorporated herein by reference in its entirety.

### FIELD OF THE DISCOSURE

The present disclosure generally relates to aqueous coolant fluids for fixed abrasive wire slicing. In particular, the present disclosure relates to coolant fluids for fixed abrasive wire slicing of silicon and other inorganic crystalline materials employed, for example, in semiconductors and photovoltaic devices.

### BACKGROUND

Silicon, sapphire, germanium and a variety of III-V crystals, such as gallium nitride or indium nitride, are some of the major raw materials used to manufacture semiconductor devices and device chips. Silicon (monocrystalline, polycrystalline and/or multi-crystalline), in addition to being used in semiconductor manufacturing, may also be used with regard to photovoltaic device manufacturing and power production (e.g., solar powered cells).

Silicon is generally less expensive compared to multi junction materials, and has proven to be often more efficient than sputtered glass substrates, such as copper indium gallium selenide (CIGS). During manufacturing, silicon is typically grown or cast into blocks or ingots, in a shape suitable for processing. These ingots can be to be sliced into individual wafers for further use in various manufacturing industries (e.g., device chip manufacturing, semiconductor device manufacturing, photovoltaic cell manufacturing, etc.).

The above-described slicing process is typically performed by using a multi-wire saw (MWS). A multi-wire saw uses a skein of wire (referred as a “web”) as a cutting surface and the ingot is either raised or lowered through the web (see FIG. 1), thereby slicing the ingot into a large number of identically sized wafers (typically 100 to 5000 wafers per ingot). The thickness of the resulting wafers is mainly determined by varying the pitch (distance between the wires).

Two general types of processes employing slicing with a MWS exist: i) slurry wire slicing and ii) fixed abrasive wire slicing. In slurry wire slicing, a slurry containing abrasive particles is put in direct contact with the wire array to help facilitate the cutting of a block or ingot, while in fixed abrasive wire slicing the abrasive is fixed or attached to the wire itself.

A type of MWS which has become an industrial standard in fixed abrasive wire slicing is a Fixed Abrasive Multi-Wire Saw (FAMWS).

When using a Fixed Abrasive Multi-Wire Saw (FAMWS), a coolant fluid (coolant) is required to reduce sawing friction and to carry away heat from the cutting zone. The physical and chemical properties of the coolant can affect the quality of the resulting wafers, such as total thickness variation (TTV), surface finish (Rₐ and R_{z}), warp, subsurface damage, and wafer scratching. In addition, the coolant can also affect the speed at which the slicing can be conducted without damaging the wafers or the wire. The coolant can also affect the ease with which the wafers can be cleaned after the cut is completed.

With regard to a desired improvement of the TTV, one well known problem in fixed abrasive wire slicing is the tailing edge effect (tail effect), which means that when the wire cuts through the final chamfer of the ingot, the thickness variation increases, so that in two wafers adjacent to one another one becomes thinner and the other one becomes thicker. This has a strong effect on the average measured TTV of the wafers.

The industry continues to demand improvements in fixed abrasive wire slicing for improved wafers and wafer yields.

### SUMMARY

In an embodiment, an aqueous coolant fluid for cutting or machining a substrate, comprising at least one organic phosphorous containing acid or salt thereof in an amount of 0.01 to 10 wt %, at least one polyol in an amount of at least 15 wt %; and at least one surfactant in an amount of 0.001 to 10.0 wt % based on total weight of the fluid. The pH value of the aqueous fluid is not higher than 7.

In another embodiment, an aqueous coolant fluid for cutting or machining a work piece which comprises an organic phosphorous containing acid or salt thereof; at least one polyol in an amount of at least 15 wt % based on the total weight of the fluid; and at least one surfactant, wherein a weight ratio of the organic phosphorous containing acid or salt thereof to the at least one non-ionic surfactant is between about 10:1 and about 1:10.

In a further embodiment, a liquid concentrate adapted for dilution with a water-based diluent to obtain a coolant fluid. The liquid concentrate comprises at least one organic phosphorous containing acid or salt thereof in an amount of about 0.02 wt % to about 30 wt %; at least one polyol in an amount of about 30 wt % to about 90 wt %; and at least one surfactant in an amount of about 0.02 wt % to about 30 wt %,

In yet another embodiment, a liquid concentrate adapted for dilution with a water-based diluent to obtain a coolant fluid. The liquid concentrate comprises at least one organic phosphorous containing acid or salt thereof; at least one polyol; and at least one surfactant, wherein a weight ratio of the organic phosphorous containing acid or salt thereof to the at least one surfactant may be between about 10:1 and 1:10, and a water content may be up to 70 wt % based on the total weight of the liquid concentrate.

In yet another embodiment, a method of cutting a substrate comprising providing an aqueous coolant fluid containing at least one organic phosphorous containing acid or salt thereof in an amount of 0.1 to 10 wt %; at least one polyol compound in an amount of at least 15 wt %; and at least one surfactant in an amount of 0.01 to 10.0 wt %, and cutting the substrate with a saw. The pH of the coolant fluid may be not higher than 7, and the cutting may include, for example, wire slicing a semiconductor substrate with a wire saw.

### BRIEF DESCRIPTION OF THE DRAWINGS

The present disclosure may be better understood, and its numerous features and advantages made apparent to those skilled in the art by referencing the accompanying drawings.

FIG. 1 is a schematic illustration of cutting an ingot with a multi-wire saw (MWS).

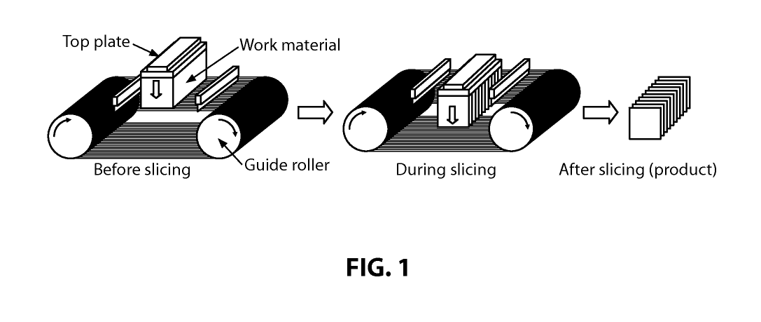

FIG. 2 is a picture of sliced silicon ingot indicating the selection of Fresh, Middle and Used sections.

FIG. 3 demonstrates a nine-point measurement location selection throughout the wafer.

FIG. 4 demonstrates a fifteen-point measurement location selection throughout the wafer.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The terminology used herein is for the purpose of describing particular embodiments only, and is not intended to be limiting.

As used herein, “Rₐ” is used to designate “average roughness,” which can be described as the arithmetic average of lengths between peaks and valleys and the deviation from the mean line on the entire surface within the sampling length. Rₐ can be reported in units of length, such as micrometers (μm).

As used herein, “R_{z}” is used to designate “mean roughness depth,” which can be described as the measure of the vertical distance from the highest peak to the lowest valley within 5 sampling lengths, and then averaging these vertical distances. R_{z} can be reported in units of length, such as micrometers (μm).

As used herein, “warp” can be described as the deviation from a plane of a slice or wafer centerline containing both concave and convex regions, thereby providing a measurement of the maximum vertical distance between the highest peak and the lowest trough of a median surface profile.

As used herein, TTV (total thickness variation) can generally be described as a measurement of the difference between the maximum and the minimum thickness of a wafer. TTV may be determined by measuring the wafer in multiple locations of a cross pattern (not too close to the wafer edge) and calculating the maximum measured difference in thickness.

As used herein, Pelgrim Mode is a parameter related to the bidirectional cutting process when using a wire saw. In a wire saw machine, it is most common for the wire to be used in a reciprocating mode, travelling a fixed distance in one direction and a lesser distance in the other direction. This causes fresh wire from the feed spool to index slowly through the ingot. This reciprocation is referred to as the Pelgrim mode and is expressed in number of meters in each direction (forward and back).

Various embodiments of the present disclosure will now be described, by way of example only, with reference to the accompanying drawings.

The present disclosure relates to an improved aqueous coolant fluid for cutting or machining a substrate which comprises an organic phosphorous containing acid or salt thereof, at least one polyol compound; and at least one surfactant. The present disclosure further relates to a liquid concentrate adapted for dilution with an aqueous solvent to obtain the coolant fluid.

The organic phosphorous containing acid or salt thereof contained in the coolant fluid may be an organic derivative of the following phosphorous containing acids: phosphoric acid, diphosphoric acid, trimetaphosphoric acid, tripolyphosphoric acid, tetrapolyphosphoric acid, perphosphoric acid, pyrophosphoric acid, hypophosphorous acid, permonophosphoric acid, metaphosphoric acid, phosphonic acid, polyphosphoric acid, and phytic acid.

Suitable examples of the at least one organic phosphorous containing acid or salt thereof can include, but are not necessarily limited to:

AEP: 2-Aminoethylphosphonic acid,

HEDP: 1-Hydroxy Ethylidene-1,1-Diphosphonic Acid,

ATMP: Amino tris(methylene phosphonic acid),

EDTMP: Ethylenediamine tetra(methylene phosphonic acid),

TDTMP: Tetramethylenediamine tetra(methylene phosphonic acid),

HDTMP: Hexamethylenediamine tetra(methylene phosphonic acid),

DTPMP: Diethylenetriamine penta(methylene phosphonic acid),

PBTC: Phosphonobutane-tricarboxylic acid,

PMIDA: N-(phosphonomethyl)iminodiacetic acid,

CEPA: 2-carboxyethyl phosphonic acid, and

AMP: Amino-tris-(methylene-phosphonic acid), and any combinations of the above-listed acids thereof.

In a preferred embodiment, the organic phosphorous containing acid may be 1-hydroxy ethyldiene-1,1-diphosphoric acid (HEDP).

In an embodiment, the organic phosphorous containing acid or salt thereof of the coolant fluid may be present in an amount of at least about 0.05 wt %, such as at least about 0.1 wt %, or at least about 0.15 wt % based on the total weight of the coolant fluid. In another embodiment, the organic phosphorous containing acid or salt thereof may be not greater than about 15 wt %, such as not greater than about 10 wt %, not greater than about 5 wt %, not greater than about 2 wt %, or not greater than about 1 wt %. It will be appreciated that the organic phosphorous containing acid or salt thereof can have an amount in a range of any of any of the maximum and minimum values noted above, such as from about 0.01 wt % to about 30 wt %, from about 0.01 wt % to about 20 wt %, from about 0.01 wt % to 15 wt %, from about 0.01 wt % to about 10 wt %, from about 0.1 wt % to about 5 wt % or from about 0.5 wt % to about 2 wt %.

Suitable polyols of the coolant fluid, but not limited to, are glycerol, alkylene glycols, glycol ethers, and combinations thereof. Suitable alkylene glycols include, but not limited to, are propylene glycol, polypropylene glycol, ethylene glycol, diethylene glycol, triethylene glycol, polyethylene glycol, polyalkylene glycol and combinations thereof. Suitable polyalkylene glycols include, but not limited to, are polyethylene glycol, polypropylene glycol, and polyalkylene block copolymers, alkoxylated alcohols such as ethoxylated and propoxylated alcohols, and combinations thereof.

In an embodiment, the at least one polyol may have an average molecular weight M_{w} of not greater than about 7,000,000 g/mol, such as not greater than about 5,00,000 g/mol, not greater than about 3,000,000 g/mol, not greater than about 1,000,000 g/mol, not greater than about 800,000 g/mol, not greater than about 500,000 g/mol, not greater than about 200,000 g/mol, not greater than about 100,000 g/mol, not greater than about 50,000 g/mol, not greater than about 20,000 g/mol, not greater than about 10,000 g/mol, not greater than about 5,000 g/mol, not greater than about 1,000 g/mol, or not greater than about 600 g/mol. In another embodiment, the at least one polyol may have an average molecular weight M_{w} of at least 62 g/mol, such as at least 100 g/mol, at least 300 g/mol, at least 500 g/mol, at least 1,000 g/mol, at least 2,000 g/mol, at least 3,000 g/mol, at least 5,000 g/mol, at least 7,000 g/mol, at least 10,000 g/mol, at least 15,000 g/mol, at least 50,000 g/mol, at least 100,000 g/mol, at least 500,000 g/mol, or at least 1,000,000 g/mol. It will be appreciated that the at least one polyol can have an average molecular weight in a range of any of the maximum and minimum values noted above, such as from about 70 g/mol to about 7,000,000 g/mol, from about 3,000 g/mol to about 1,000,000 g/mol, or from about 10,000 g/mol to about 500,000 g/mol.

In a particular embodiment, the polyol contained in the coolant fluid may be diethylene glycol, triethylene glycol and/or polyethylene glycol up to a molecular weight M_{w} of 500 g/mol.

In another embodiment, the at least one polyol may be present in the aqueous coolant fluid in an amount of not greater than about 90 wt %, such as not greater than about 85 wt %, not greater than about 80 wt %, not greater than about 75 wt %, not greater than about 70 wt %, or not greater than about 65 wt %, based on the total weight of the aqueous fluid. In a further embodiment, the at least one polyol may be present in the aqueous coolant fluid in an amount of at least about 15 wt %, such as at least about 20 wt %, at least about 25 wt %, at least about 27 wt %, at least about 30 wt %, or at least about 33 wt % based on the total weight of the aqueous fluid. It will be appreciated that the at least one polyol can have an amount in a range of any of the maximum and minimum values noted above, such as from about 15 wt % to about 95 wt %, from about 25 wt % to about 80 wt %, or from about 30 wt % to about 65 wt %.

The surfactant of the aqueous cooling fluid may have cationic, anionic, nonionic, amphoteric or zwitterionic character. In a preferred aspect, the at least one surfactant may be a nonionic and/or a cationic surfactant. Suitable surfactants may include, but are not limited to, ethoxylated fatty amines, alcohol ethoxylate-based surfactants, polysorbates, or silicone-based surfactants. In a preferred aspect, the surfactant may be an alkyl ethoxylated amine oxide having the structure CH₃(CH₂)ₓCH₂O(CH₂)₃NO[(CH₂CH₂O)_{y}H]₂, where x=2 to 8 and y=1, of which an example is TOMAH AO-405 from Dow Chemical Inc.

In one embodiment, the at least one surfactant may be present in the aqueous coolant fluid in an amount of not greater than 18 wt %, such as not greater than about 15 wt %, not greater than about 10 wt %, not greater than about 5 wt %, not greater than about 3 wt %, or not greater than about 1 wt % based on the total weight of the coolant fluid. In a further embodiment, the at least one surfactant may be present in an amount of at least about 0.02 wt %, such as at least about 0.04 wt %, at least about 0.06 wt %, at least about 0.08 wt % or at least about 0.1 wt %. It will be appreciated that the surfactant can have an amount in a range of any of the maximum and minimum values noted above, such as from about 0.001 wt % to about 20 wt %, from about 0.01 wt % to about 15 wt %, from about 0.01 wt % to about 10 wt %, from about 0.01 to about 5 wt %, from about 0.1 wt % to about 3 wt %, or from about 0.05 wt % to about 1 wt %.

In yet a further embodiment, the water content of the coolant fluid may be not greater than 80 wt %, such us not greater than 75 wt %, not greater than 70 wt % or not greater than 65 wt % based on the total weight of the coolant fluid. In a further aspect, the water content can be at least about 2 wt %, such as at least about 5 wt %, at least about 10 wt %, at least about 20 wt %, or at least about 30 wt %. It will be appreciated that the water content can have an amount in a range of any of the maximum and minimum values noted above, such as from about 1 wt % to about 85 wt %, from about 20 wt % to about 70 wt % or from about 30 wt % to about 65 wt %.

The coolant fluid of the present invention is further characterized by specific weight ratios between the components of the fluid.

In one embodiment, the weight ratio between the phosphorous containing acid or salt thereof and the at least one surfactant in the coolant fluid may be from 10:1 to 1:10, preferably from 10:1 to 1:1, or from 8:1 to 1:1. It will be appreciated that the weight ratios between the phosphorous containing acid or salt thereof and the at least one surfactant can have any ratio in a range of any of the maximum and minimum ratios noted above.

In another embodiment, the weight ratio between the phosphorous containing acid or salt thereof and the at least one polyol in the coolant fluid may be from 1:50 to 1:600, preferably from 1:100 to 1:500. It will be appreciated that the weight ratio between the phosphorous containing acid or salt thereof and the at least one polyol can have any ratio in a range of any of the maximum and minimum ratios noted above.

In yet another embodiment, the weight ratio between the surfactant and the polyglycol in the coolant fluid may be from 1:100 to 1:1200. It will be appreciated that the weight ratios between the surfactant and the polyglycol can have any ratio in a range of the maximum and minimum ratios noted above.

In a further embodiment, the weight ratio a:b:c between the phosphorous containing acid or salt thereof (a), the surfactant (b), and the polyol (c) in the coolant fluid can be from 1:1:100 to 1:10:1200. It will be appreciated that the weight ratio between the phosphorous containing acid or salt thereof (a), the surfactant (b), and the polyol (c) can have any ratio in a range of the maximum and minimum ratios noted above.

In another embodiment, the coolant fluid may have a pH of not greater than about 7.0, such as not greater than about 6.5, not greater than about 6.0, not greater than about 5.5, not greater than about 5.0, not greater than about 4.0, or not greater than about 3.5. In yet another embodiment, the cooling fluid may have a pH of at least 1.0, such as at least 1.5, at least 2.0, at least 2.5, at least 3.0, or at least 3.5. It will be appreciated that the pH value of the coolant fluid can be in a range of any of the maximum and minimum values noted above, such as from 7.0 to 1.0, from 6.0 to 3.0, or from 5 to 3.0.

Optionally, the aqueous coolant fluid of the present disclosure may also include at least one additive. Suitable additives may include, but are not limited to, defoamers, biocides, dispersants, corrosion inhibitors, dyes, viscosity regulating agents, organic solvents or fragrances.

In one embodiment, the at least one optional additive may be present in an amount of not greater than 30 wt %, such as not greater than 25 wt %, not greater than 20 wt %, not greater than 15 wt %, not greater than 10 wt %, or not greater than 5 wt % based on the total weight of the cooling fluid. In a further embodiment, the amount of the at least one additional ingredient can be at least 0.001 wt %, such as at least 0.1 wt %, at least 0.5 wt %, or at least 1 wt %, based on the total weight of the coolant fluid. It will be appreciated that the at least one optional additional ingredient can have an amount in a range of any of the maximum and minimum values noted above, such as from 0.001 wt % to 30 wt %, from 0.5 wt % to 20 wt %, or from 1 wt % to 10 wt %.

Suitable defoamers may include, but are not limited to, oil based defoamers, powder defoamers, water based defoamers, silicone and siloxane based defoamers, or any suitable material that reduces the amount of foam. In one aspect, the defoamer may be present in an amount ranging from 0.001 wt % to 0.1 wt %. Preferably, the amount of the defoamer may range from 0.001 wt % to 0.005 wt %.

In one embodiment, the coolant fluid is essentially free of inorganic or organic bentonite. Under essentially free should be understood amounts lower than 0.05 wt % of inorganic or organic bentonite based on the total weight of the coolant fluid.

In a particular embodiment, the aqueous coolant fluid may comprise at least one organic phosphorous containing acid or salt thereof in an amount of 0.1 to 1 wt %; at least one polyol compound in an amount of at least 25 wt % and not greater than 75 wt %, and at least one surfactant in an amount of 0.001 to 2 wt % based on the total weight of the coolant fluid.

In another particular embodiment, the aqueous coolant fluid may comprise 1-hydroxy ethylidene-1,1-diphosphonic acid (HEDP) in an amount of 0.1 to 5 wt %; at least one polyol compound in an amount of at least 25 wt % and not higher than 75 wt %, and at least one non-ionic or cationic surfactant in an amount of 0.001 to 5 wt % based on the total weight of the aqueous coolant fluid. Preferably, the polyol may be diethylene glycol, triethylene glycol or a polyethylene glycol with a molecular weight M_{w} up to 500 g/mol.

In a further embodiment, the aqueous coolant fluid may comprise at least one organic phosphorous containing acid or salt thereof, at least one polyol in an amount of at least 15 wt % based on the total weight of the coolant fluid, and at least one surfactant, wherein the weight ratio between the organic phosphorous containing acid or salt thereof to the at least one surfactant may be between about 10:1 and 1:1, preferably between about 8:1 and 1:1.

In yet a further embodiment, the aqueous coolant fluid may comprise at least one organic phosphorous containing acid or salt thereof, at least one polyol in an amount of at least 15 wt % based on the total weight of the coolant fluid, and at least one surfactant. The weight ratio between the organic phosphorous containing acid or salt thereof to the at least one surfactant may be between about 10:1 and 1:10, preferably between about 8:1 and 1:1. Furthermore, the ratio between the organic phosphorous containing acid or salt thereof to the polyol may be between about 1:500 to about 1:40, and the ratio between the amount of surfactant and the polyol may be between about 1:1,200 and about 1:100.

The present disclosure further relates to a liquid concentrate adapted for dilution with a water-based diluent to obtain the coolant fluid of the present invention. Accordingly, the liquid concentrate may include the same ingredients as contained in the coolant fluid of the present invention, i.e., at least one organic phosphorous containing acid or salt thereof, at least one polyol, at least one surfactant, water, and at least one optional additive.

In one embodiment, the liquid concentrate may be adapted that a ratio of the liquid concentrate to water for dilution of the concentrate to obtain the coolant fluid may be from about 1:0.5 to about 1:10. In a preferred embodiment, the ratio of the concentrate to the water for dilution of the concentrate may be from about 1:1 to about 1:3; most preferred, the ratio may be about 1:1.

In a further embodiment, the liquid concentrate may comprise the organic phosphorous containing acid or salt thereof in an amount of at least about 0.1 wt %, such as at least about 0.2 wt %, or at least about 0.5 wt %. In another embodiment, the organic phosphorous containing acid or salt thereof of the liquid concentrate may be not greater than about 35 wt %, such as not greater than about 30 wt %, not greater than about 20 wt %, not greater than about 10 wt %, not greater than about 5 wt %, or not greater than about 3 wt %. It will be appreciated that the organic phosphorous containing acid or salt thereof can have an amount within a range between any of the minimum and maximum values noted above, such as from about 0.02 wt % to about 40 wt %, from about 0.02 wt % to about 30 wt %, from about 0.02 wt % to about 20 wt %, from about 0.02 wt % to about 15 wt %, from about 0.01 wt % to about 10 wt %, or from about 0.1 wt % to about 5 wt %.

In another embodiment, the amount of the at least one polyol in the liquid concentrate may be at least about 25 wt %, such as at least about 30 wt %, at least about 35 wt %, at least about 40 wt %, or at least about 50 wt % based on the total weight of the concentrate. In a further aspect, the at least one polyol may be present in an amount of not greater than about 95 wt %, such as not greater than about 90 wt %, not greater than about 80 wt %, not greater than about 75 wt %, or not greater than about 70 wt %. It will be appreciated that the at least one polyol can have an amount in a range of any of the maximum and minimum values noted above, such as from about 25 wt % to about 95 wt %, from about 30 wt % to about 70 wt %, or from about 35 wt % to about 50 wt %.

In one embodiment, the at least one surfactant of the liquid concentrate may be present in an amount of at least about 0.02 wt %, such as at least about 0.1 wt %, at least about 0.5 wt %, at least about 1 wt % or at least about 3 wt % based on the total weight of the concentrate. In another embodiment, an amount of the at least one surfactant may not be greater than 28 wt %, such as not greater than about 25 wt %, not greater than about 20 wt %, not greater than about 15 wt %, not greater than about 10 wt %, or not greater than about 5 wt %. It will be appreciated that the at least one surfactant can have an amount in a range of any of the maximum and minimum values noted above, such as from about 0.002 wt % to 25 wt %, from about 0.01 wt % to about 20 wt %, from about 0.02 wt % to about 15 wt %, from about 0.02 wt % to about 10 wt %, from about 0.01 wt % to about 5 wt %, or from about 0.01 wt % to about 3 wt %.

The water-based diluent for diluting the liquid concentrate to obtain the coolant fluid may be deionized water or a mixture of water and a water-miscible organic solvent, for example, a mixture of water and a lower alcohol, such as methanol, ethanol, or isopropanol. Preferably, the water-based diluent may be deionized water.

In yet a further embodiment, the water content of the liquid concentrate (before dilution) may be at least about 0.5 wt %, such as at least about 1 wt %, at least about 2 wt %, at least about 5 wt %, at least about 10 wt % or at least about 15 wt % based on the total weight of the liquid concentrate. In another aspect, the water content may be not greater than about 70 wt %, such as not greater than about 60 wt %, not greater than about 50 wt %, not greater than about 35 wt %, not greater than about 30 wt %, not greater than about 25 wt %, or not greater than about 20 wt %. Preferably, the water content of the liquid concentrate may be not greater than about 30 wt %. It will be appreciated that the water content can be in a range of any of the maximum and minimum values noted above, such as from about 0.5 wt % to about 70 wt %, from about 3 wt % to about 55 wt %, or from about 5 wt % to about 30 wt %.

In one embodiment, the liquid concentrate may have a pH not greater than 7.0, such as not greater than 6.5, not greater than 6.0, not greater than 5.5, not greater than 5.0, not greater than 4.5, not greater than 4.0, not greater than 3.5, or not greater than 3.0. In another embodiment, the pH value of the liquid concentrate can be at least 1.5, such as at least 2.0 or at least 3.0 It will be appreciated that the pH value of the concentrate can be in a range of any of the minimum and maximum values noted above, such as from 1.5 to 7.0, from 2.0 to 6.5 or from 3 to 5.5.

In yet another embodiment, the liquid concentrate may have a weight ratio of the at least one organic phosphorous containing acid or salt thereof to the at least one surfactant from about 10:1 to about 1:10. In a particular embodiment, the ratio of the at least one organic phosphorous containing acid or salt thereof to the at least one surfactant may be from about 10:1 to about 1:1, such as from about 8:1 to about 1:1, or from about 5:1 to about 1:1. It will be appreciated that the weight ratios between the phosphorous containing acid or salt thereof and the at least one surfactant in the concentrate can be in a range of any of the maximum and minimum ratios noted above.

In other embodiments, the weight ratio between the phosphorous containing acid or salt thereof and the at least one polyol in the liquid concentrate may be from about 1:50 to about 1:600, preferably from about 1:100 to about 1:500. It will be appreciated that the weight ratio between the phosphorous containing acid or salt thereof and the at least one polyol of the concentrate can be in a range of any of the maximum and minimum ratios noted above.

In yet other embodiments, the weight ratio between the surfactant and the polyglycol of the concentrate may be from about 1:100 to about 1:1200. It will be appreciated that the weight ratio between the surfactant and the polyglycol of the concentrate can be in a range of any of the maximum and minimum ratios noted above.

In a further embodiment, the weight ratio a:b:c between the phosphorous containing acid or salt thereof (a), the surfactant (b), and the polyol (c) in the liquid concentrate may be between about 1:1:100 to about 1:10:1200. It will be appreciated that the weight ratio a:b:c in the concentrate can be in a range of any of the maximum and minimum ratios noted above.

The present disclosure furthermore relates to a method of cutting a substrate using the coolant fluid described in the present disclosure.

In one embodiment, the method may include providing a coolant fluid containing an organic phosphorous containing acid compound or salt thereof in an amount of about 0.1 to about 10 wt %; at least one polyol at a content of at least 15 wt %; and at least one surfactant at a content of 0.01 to 10.0 wt %, wherein a pH value of the fluid is not greater than about 7; and cutting the substrate with a saw.

In one embodiment, the cutting of the method may include wire slicing a substrate with a wire saw. In a particular embodiment, the wire saw can be a fixed abrasive multi-wire saw (FAMWS).

In a further embodiment, the substrate of the method may be an inorganic crystalline material employed for manufacturing wafers (e.g., semiconductor or insulating wafers) or photovoltaic cells. For example, the material of the substrate may be semiconductor, insulating, silicon, sapphire, germanium, a Group III-V material (e.g., GaN), and any combination thereof. In aspects, the Group III-V material may be indium nitride or gallium nitride. In a preferred embodiment, the substrate may be in the form of an ingot, which is a large material that can be sectioned by the fixed abrasive wire to form wafers. According to one embodiment, the ingot can include a semiconductor material or insulating material. In another embodiment, the ingot can be a silicon ingot or a silicon wafer.

It has been surprisingly discovered that by using the coolant fluid of the present invention for fixed abrasive wire slicing of a silicon ingot, there is a marked improvement in the wafer quality, specifically with regard to an even thickness throughout the wafer, including at the edges of the wafer. As further demonstrated in the examples, by using the coolant fluid of the present invention for fixed abrasive wire slicing, very evenly cut wafers with only minor tailing edge effects could be obtained. It could be demonstrated that wafers cut with the coolant fluid of the present invention have lower TTV values in comparison to coolant fluids representative for the state of the art.

In one embodiment, an average surface roughness Rₐ of the substrate after cutting with a FAMWS is not greater than 1.5 μm, such as not greater than 1.2 μm, not greater than 1.0 μm, not greater than 0.8 μm, or not greater than 0.6 μm.

In another embodiments, an average surface roughness R_{z} of the substrate after cutting is not greater than 7 μm, such as not greater than 6 μm, not greater than 5 μm, not greater than 4 μm, or not greater than 3.5 μm.

In yet a further embodiment, the substrate after cutting has a total thickness variation (TTV) with tail effect of not greater than 50 μm, such as not greater than 45 μm, not greater than 40 μm, not greater than 35 μm, not greater than 30 μm, not greater than 25 μm, not greater than 20 μm, or not greater than 15 μm.

Without wishing to be bound by theory, it appears that the combination of components of the cooling fluid of the embodiments herein improves the cutting performance by synergistically interacting with the wire and silicon surfaces.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Items

Item 1: An aqueous coolant fluid for cutting or machining a substrate, comprising: at least one organic phosphorous containing acid or salt thereof in an amount of 0.01 wt % to 10 wt % based on the total weight of the coolant fluid; at least one polyol in an amount of at least 15 wt % based on the total weight of the coolant fluid; and at least one surfactant in an amount of 0.001 wt % to 10.0 wt % based on total weight of the coolant fluid, wherein a pH value of the fluid is not greater than 7.

Item 2: An aqueous coolant fluid for cutting or machining a work piece, comprising an organic phosphorous containing acid or salt thereof; at least one polyol in an amount of at least 15 wt % based on total weight of the coolant fluid; and at least one surfactant, wherein a weight ratio of the organic phosphorous containing acid to the at least one non-ionic surfactant is from about 10:1 to about 1:10.

Item 3: The aqueous coolant fluid of items 1 or 2, wherein the organic phosphorous containing acid is selected from the group consisting of 2-Aminoethylphosphonic acid (AEP); 1-Hydroxy Ethylidene-1,1-Diphosphonic Acid (HEDP); Amino tris(methylene phosphonic acid) (ATMP); Ethylenediamine tetra(methylene phosphonic acid (EDTMP); Tetramethylenediamine tetra(methylene phosphonic acid (TDTMP); Hexamethylenediamine tetra(methylene phosphonic acid (HDTMP); Diethylenetriamine penta(methylene phosphonic acid (DTPMP); Phosphonobutane-tricarboxylic acid (PBTC); N-(phosphonomethyl)iminodiacetic acid (PMIDA); 2-carboxyethyl phosphonic acid (CEPA); and Amino-tris-(methylene-phosphonic acid (AMP).

Item 4: The aqueous coolant fluid of item 3, wherein the organic phosphorous containing acid comprises 1-Hydroxy Ethylidene-1,1-Diphosphonic Acid (HEDP).

Item 5: The aqueous coolant fluid of any of items 1 to 4, wherein the at least one polyol includes at least one member selected from glycerol, ethylene glycol, diethylene glycol, triethylene glycol, a polyethylene glycol, a glycolether, a polypropyleneglycol, a block-copolymer including polyethylene glycol and/or polypropylene glycol, an alkoxylated alcohol, or combinations thereof.

Item 6: The aqueous coolant fluid of any of items 1 to 5, wherein the polyol has an average molecular weight M_{w} of at least about 70 to about 7,000,000 g/mol.

Item 7: The aqueous coolant fluid of item 5, wherein the polyol is diethylene glycol, triethylene glycol or polyethylene glycol up to a molecular weight M_{w} of 500 g/mol.

Item 8: The aqueous coolant fluid of any of items 1 to 7, further comprising at least one additive, the at least one additive including a dispersant, a corrosion inhibitor, a defoamer, a dye, a fragrance, or a biocide.

Item 9: The aqueous coolant fluid of item 8, wherein the at least one additive is a defoamer.

Item 10: The aqueous coolant fluid of item 9, wherein an amount of the defoamer is about 0.001 to 0.1 wt % based on the total weight of the composition.

Item 11: The aqueous coolant fluid of any of items 1 to 10, wherein the pH of the coolant fluid is not greater than 6.5, such as not greater than 6.0, not greater than 5.5, not greater than 5.0, not greater than 4.5, not greater than 4, not greater than 3.5, or not greater than 3.0.

Item 12: The aqueous coolant fluid of item 1, wherein the amount of organic phosphorous containing acid is at least 0.1 wt %, such as at least 0.12 wt %, or at least 0.15 wt % based on total weight of the coolant fluid.

Item 13: The aqueous coolant fluid of item 1, wherein the amount of organic phosphorous containing acid or salt thereof is not greater than 8 wt %, such as not greater than 5 wt %, not greater than 3 wt % or not greater than 1 wt % based on total weight of the coolant fluid.

Item 14: The aqueous coolant fluid of item 1, wherein the amount of the at least one surfactant is at least 0.01 wt %, such as at least 0.02 wt %, at least 0.03 wt %, at least 0.04 wt % or at least 0.05 wt % based on total weight of the coolant fluid.

Item 15: The aqueous coolant fluid of item 1, wherein the amount of the at least one surfactant is not greater than 8 wt %, such as not greater than 6 wt %, not greater than 4 wt %, not greater than 3 wt %, not greater than 2 wt %, not greater than 1 wt %, or not greater than 0.05 wt % based on total weight of the coolant fluid.

Item 16: The aqueous coolant fluid of item 1, wherein the amount of polyol is at least 20 wt %, such as at least 25 wt %, at least 30 wt %, at least 33 wt %, or at least 35 wt %.

Item 17: The aqueous coolant fluid of item 2, wherein the weight ratio of the organic phosphorous containing acid or salt thereof to the at least one surfactant is from about 10:1 to about 1:1, such as from about 8:1 to about 1:1, or from about 5:1 to about 1:1.

Item 18: The aqueous coolant fluid of item 2, wherein the weight ratio of the organic phosphorous containing acid or salt thereof to the at least one polyol compound is from about 1:500 to about 1:100.

Item 19: The aqueous coolant fluid of items 1 or 2, wherein the coolant fluid is essentially free of an organic or inorganic bentonite.

Item 20: The aqueous coolant fluid of items 1 or 2, wherein the at least one surfactant is a nonionic and/or cationic surfactant.

Item 21: A method of cutting a substrate, comprising providing a coolant fluid containing an organic phosphorous containing acid compound or salt thereof in an amount of 0.1 to 10 wt % based on the total weight of the coolant fluid; at least one polyol in an amount of at least 15 wt % based on the total weight of the coolant fluid; and at least one surfactant in an amount of 0.01 to 10.0 wt % based on the total weight of the coolant fluid, wherein a pH value of the fluid is not greater than about 7; and cutting the substrate with a saw.

Item 22: The method of item 21, wherein the cutting includes wire slicing a semiconductor substrate with a wire saw.

Item 23: The method of item 22, wherein the wire saw is a fixed abrasive multi-wire saw.

Item 24: The method of items 22 or 23, wherein the semiconductor substrate is a wafer or an ingot including silicon, sapphire, an III-V material, or combinations thereof.

Item 25: The method of item 24, wherein the substrate is a silicon wafer or a silicon ingot.

Item 26: The method of item 24, wherein the III-V material includes GaN and/or InN.

Item 27: The method of item 25, wherein an average surface roughness Rₐ of a silicon wafer obtained after cutting the silicon ingot is not greater than 1.5 μm, such as not greater than 1.2 μm, not greater than 1.0 μm, not greater than 0.8 μm, or not greater than 0.6 μm.

Item 28: The method of item 25, wherein an average surface roughness R_{z} of a silicon wafer obtained after cutting the silicon ingot is not greater than 7 μm, such as not greater than 6 μm, not greater than 5 μm, not greater than 4 μm, or not greater than 3.5 μm.

Item 29: The method of item 25, wherein a silicon wafer obtained after cutting the silicon ingot has a total thickness variation (TTV) with tail effect of not greater than 50 μm, such as not greater than 45 μm, not greater than 40 μm, not greater than 35 μm, not greater than 30 μm, not greater than 25 μm, not greater than 20 μm, or not greater than 15 μm.

Item 30: The method of any of items 21 to 29, wherein the at least one surfactant is a nonionic and/or cationic surfactant.

Item 31: A liquid concentrate adaptable for dilution with a water-based diluent to obtain a coolant fluid, the liquid concentrate comprising: at least one organic phosphorous containing acid or salt thereof in an amount of 0.02 wt % to 30 wt % based on the total weight of the liquid concentrate; at least one polyol in an amount of 30 wt % to 90 wt % based on the total weight of the liquid concentrate; and at least one surfactant in an amount of 0.002 wt % to 30 wt % based on the total weight of the liquid concentrate.

Item 32: A liquid concentrate adaptable for dilution with a water-based diluent to obtain a coolant fluid, comprising at least one organic phosphorous containing acid or salt thereof; at least one polyol; and at least one surfactant, wherein a weight ratio of the at least one organic phosphorous containing acid or salt thereof to the at least one surfactant is from about 10:1 to about 1:10, and a water content is up to about 70 wt % based on the total weight of the liquid concentrate.

Item 33: The liquid concentrate of item 32, wherein the ratio of the at least one organic phosphorous containing acid or salt thereof to the at least one non-ionic surfactant is from about 10:1 to about 1:1, such as from about 8:1 to about 1:1, or from about 5:1 to about 1:1.

Item 34: The liquid concentrate of item 32, wherein the weight ratio of the organic phosphorous containing acid or salt thereof to the at least one polyol is from about 1:500 to about 1:100.

Item 35: The liquid concentrate of items 31 or 32, wherein at a ratio of liquid concentrate to the water-based diluent is from about 1:0.5 to about 1:10, such as from about 1:1 to about 1:3.

Item 36: The liquid concentrate of items 31 or 32, wherein the organic phosphorous containing acid is selected from the group consisting of 2-Aminoethylphosphonic acid (AEP); 1-Hydroxy Ethylidene-1,1-Diphosphonic Acid (HEDP); Amino tris(methylene phosphonic acid) (ATMP); Ethylenediamine tetra(methylene phosphonic acid (EDTMP); Tetramethylenediamine tetra(methylene phosphonic acid (TDTMP); Hexamethylenediamine tetra(methylene phosphonic acid (HDTMP); Diethylenetriamine penta(methylene phosphonic acid (DTPMP); Phosphonobutane-tricarboxylic acid (PBTC); N-(phosphonomethyl)iminodiacetic acid (PMIDA); 2-carboxyethyl phosphonic acid (CEPA); and Amino-tris-(methylene-phosphonic acid (AMP).

Item 37: The liquid concentrate of item 36, wherein the at least one organic phosphorous containing acid or salt thereof comprises 1-Hydroxy Ethylidene-1,1-Diphosphonic Acid (HEDP).

Item 38: The liquid concentrate of any of items 31 to 37, wherein the at least one polyol includes at least one member selected from glycerol, ethylene glycol, diethylene glycol, triethylene glycol, a polyethylene glycol, a glycolether, a polypropyleneglycol, a block-copolymer including polyethylene glycol and/or polypropylene glycol, an alkoxylated alcohol, or combinations thereof.

Item 39: The liquid concentrate of any of items 31 to 38, wherein the polyol has an average molecular weight M_{w} of at least about 70 to about 7,000,000 g/mol.

Item 40: The liquid concentrate of item 38, wherein the polyol is diethylene glycol, triethylene glycol or polyethylene glycol up to a molecular weight M_{w} of 500 g/mol.

Item 41: The liquid concentrate of any of items 31 to 40, further comprising at least one additive, the additive including a dispersant, a corrosion inhibitor, a defoamer, a dye, a fragrance, or a biocide.

Item 42: The liquid concentrate of item 41, wherein the at least one additive is a defoamer.

Item 43: The liquid concentrate of item 42, wherein an amount of the defoamer ranges from 0.001 to 0.1 wt % based on the total weight of the liquid concentrate.

Item 44: The liquid concentrate of any of items 31 to 43, wherein the water-based diluent is deionized water.

Item 45: The liquid concentrate of any of items 31 to 44, wherein a pH of the concentrate is not greater than 6.0, such as not greater than 5.5, not greater than 5.0, not greater than 4.5, not greater than 4.0, not greater than 3.5, or not greater than 3.0.

Item 46: The liquid concentrate of any of items 31 to 45, wherein the coolant fluid is essentially free of an organic or inorganic bentonite.

Item 47: The liquid concentrate of any of items 31 to 46, wherein the at least one surfactant is a nonionic and/or cationic surfactant.

The present disclosure may be further understood with reference to the following Examples.

### EXAMPLES

### Example 1

An aqueous fluid was formed including as an organic phosphorous containing acid 1-hydroxy ethylidene-1,1-diphosphonic acid in an amount of 0.15 weight %, based on the total weight of the aqueous fluid. The 1-hydroxy ethylidene-1,1-diphosphonic acid was partially neutralized with ammonium hydroxide to a resultant pH of 5.65. Furthermore, 70 wt % diethylene glycol, 0.0625 wt % of an ethoxylated amine oxide surfactant (TOMAH AO-405, which is pH dependent and becomes cationic with increasing acidic character of the solution), and 0.002 wt % of a siloxane based defoamer (Foam Ban MS550) were added to the fluid. The remainder of the formulation constituted water.

### Example 2

An aqueous fluid was formed including as an organic phosphorous containing acid 1-hydroxy ethylidene-1,1-diphosphonic acid in an amount of 0.3 wt % based on the total weight of the aqueous fluid. The 1-hydroxy ethylidene-1,1-diphosphonic acid was partially neutralized with ammonium hydroxide to a resultant pH of 5.65.

Furthermore, 65 wt % triethylene glycol, 0.0625 wt % ethoxylated amine oxide surfactant as used in Example 1 (TOMAH AO-405) and 0.002 wt % of a siloxane based defoamer (Foam Ban MS550) were added to the fluid. The remainder of the formulation constituted water.

### Example 3

An aqueous fluid was formed including as organic phosphorous containing acid phytic acid in an amount of 0.5 wt % based on the total weight of the aqueous fluid. The phytic acid was partially neutralized with ammonium hydroxide to a pH of 5.0.

Furthermore, 65 wt % of PEG-4 (polyethylene glycol with a molecular weight of about 200 g/mol), 0.0625 wt % of ethoxylated amine oxide surfactant as used in Examples 1 and 2 (TOMAH AO-405), and 0.002 wt % of a siloxane based defoamer (Foam Ban MS550) were added to the fluid. The remainder of the formulation constituted water.

### Example 4

An aqueous fluid was formed including as organic phosphorous containing acid 1-hydroxy ethylidene-1,1-diphosphonic acid in an amount of 0.35 wt % based on the total weight of the aqueous fluid. The 1-hydroxy ethylidene-1,1-diphosphonic acid was partially neutralized with ammonium hydroxide to a pH of 3.5.

Furthermore, 35 wt % of diethylene glycol, 0.15 wt % of ethoxylated amine oxide surfactant as also used in Examples 1-3 (TOMAH AO-405) and 0.002 wt % of a siloxane based defoamer (Foam Ban MS550) were added to the fluid. The remainder of the formulation was water.

### Example 5

An aqueous fluid was formed including as organic phosphorous containing acid 1-hydroxy ethylidene-1,1-diphosphonic acid in an amount of 0.35 wt % based on the total weight of the aqueous fluid. The 1-hydroxy ethylidene-1,1-diphosphonic acid was partially neutralized with ammonium hydroxide to a pH of 3.5.

Furthermore, 35 wt % of diethylene glycol, and 0.3 wt % of a nonionic ethoxylated diol surfactant (Surfynol 440) were added. This solution was low-foaming and therefore a defoamer was not included in the formulation. The remainder of the formulation was water.

### Comparative Example 6

An aqueous fluid was formed including as organic phosphorous containing acid 1-hydroxy ethylidene-1,1-diphosphonic acid in an amount of 0.35 wt % based on the total weight of the aqueous fluid. The 1-hydroxy ethylidene-1,1-diphosphonic acid was partially neutralized with ammonium hydroxide to a resultant pH of 3.5.

Furthermore, 35 wt % of diethylene glycol was added to the fluid. The remainder of the formulation was water. No surfactant and no defoamer were used in this formulation.

All wt % concentration in examples 1 to 6 were based on the total weight of the respective aqueous fluid composition.

Table 1 shows a summary of the compositions of Examples 1-5 and Comparative Example 6.

TABLE 1

| | | | | | | Comp. |
|---|---|---|---|---|---|---|
| | Ex. 1 | Ex. 2 | Ex. | Ex. 4 | Ex. 5 | Ex. 6 |
| | [wt %] | [wt %] | [w %] | [wt %] | [wt %] | [wt %] |
| HEDP | 0.15 | 0.3 | 0.5 | 0.35 | 0.35 | 0.35 |
| Surfactant | 0.0625 | 0.0625 | 0.0625 | 0.15 | 0.3 | 0 |
| Polyol | 70 | 65 | 65 | 35 | 35 | 35 |
| Water | 29.785 | 34.635 | 34.435 | 64.498 | 64.35 | 64.65 |
| Defoamer | 0.002 | 0.002 | 0.002 | 0.002 | 0 | — |
| Ratio | 2.42/1 | 4.8/1 | 8/1 | 2.33/1 | 1.17/1 | — |
| HEDP/surfactant | | | | | | |
| Ratio | 1/467 | 1/217 | 1/130 | 1/100 | 1/100 | 1/100 |
| HEDP/polyol | | | | | | |
| Ratio | 1/1129 | 1/1040 | 1/1040 | 1/233.3 | 1/116.7 | — |
| surfactant/polyol | | | | | | |

### Example 7

### Cutting Performance and Resultant Wafer Quality

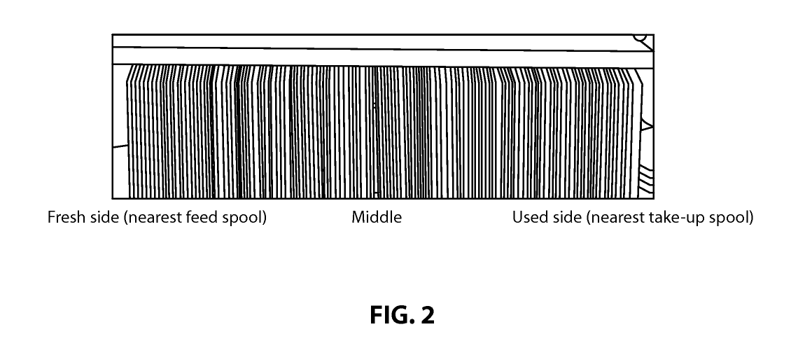

A 125 mm semi-square ingot of monocrystalline silicon was sliced using the solution of Example 1 with a fixed abrasive diamond wire (supplied by Bekaert). The wire saw machine was a multi-wire saw Meyer Burger DS265 with a table speed (cut rate) of 1 mm/minute, a wire speed of 14 m/s; a Pelgrim mode of 350 meters forward and 349 meters back; and a wire pitch of 315 microns. The ingot was mounted using epoxy. Nine of the resultant wafers from three separate areas of the sliced silicon ingot, i.e., areas employing fresh, middle, and used abrasive wire (see FIG. 2) were cleaned and measured for TTV, Rₐ and, R_{z}.

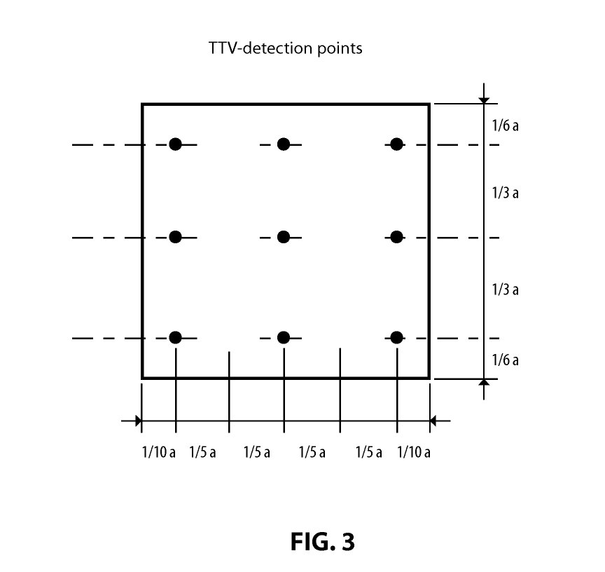

The surface finish properties Rₐ and R_{z} were measured using an optical profilometer. Nine points were tested on each wafer. The selection of the nine measuring points throughout the wafer is demonstrated in FIG. 3. The results of the Rₐ and R_{z} measurements are summarized in Tables 2A and 2B.

TABLE 2A
Measurement data of Rₐ, and R_{z} by 9-points measurement throughout
the silicon wafer (coolant fluid of Example 1 was used for wafer slicing):

| | | |
|---|---|---|
| Profile | Rₐ [μm | R_{z} [μm] |

Fresh 1

| | | |
|---|---|---|
| 1 | 0.559 | 3.442 |
| 2 | 0.557 | 3.594 |
| 3 | 0.504 | 2.974 |
| 4 | 0.505 | 3.144 |
| 5 | 0.449 | 2.725 |
| 6 | 0.482 | 3.242 |
| 7 | 0.471 | 2.99 |
| 8 | 0.469 | 2.909 |
| 9 | 0.48 | 2.749 |
| AVE | 0.4973 | 3.0854 |
| STD | 0.0384 | 0.2978 |

Middle

| | | |
|---|---|---|
| 1 | 0.414 | 2.721 |
| 2 | 0.429 | 2.74 |
| 3 | 0.418 | 2.87 |
| 4 | 0.481 | 3.164 |
| 5 | 0.443 | 2.991 |
| 6 | 0.469 | 3.026 |
| 7 | 0.476 | 3.197 |
| 8 | 0.453 | 2.859 |
| 9 | 0.431 | 2.791 |
| AVE | 0.446 | 2.9288 |
| STD | 0.0250 | 0.1756 |

Used

| | | |
|---|---|---|
| 1 | 0.446 | 2.702 |
| 2 | 0.429 | 2.778 |
| 3 | 0.391 | 2.631 |
| 4 | 0.361 | 2.666 |
| 5 | 0.394 | 2.573 |
| 6 | 0.404 | 2.532 |
| 7 | 0.431 | 3.397 |
| 8 | 0.446 | 3.12 |
| 9 | 0.44 | 2.885 |
| AVE | 0.4158 | 2.8093 |
| STD | 0.0297 | 0.2840 |

Fresh 2

| | | |
|---|---|---|
| 1 | 0.551 | 3.564 |
| 2 | 0.5 | 3.416 |
| 3 | 0.569 | 3.583 |
| 4 | 0.441 | 3.051 |
| 5 | 0.478 | 3.002 |
| 6 | 0.578 | 5.926 |
| 7 | 0.527 | 2.92 |
| 8 | 0.53 | 3.25 |
| 9 | 0.536 | 2.992 |
| AVE | 0.5233 | 3.5227 |
| STD | 0.0439 | 0.9358 |

Middle

| | | |
|---|---|---|
| 1 | 0.45 | 2.722 |
| 2 | 0.451 | 2.926 |
| 3 | 0.479 | 2.823 |
| 4 | 0.491 | 2.945 |
| 5 | 0.554 | 3.749 |
| 6 | 0.498 | 3.104 |
| 7 | 0.454 | 2.982 |
| 8 | 0.481 | 3.459 |
| 9 | 0.454 | 3.226 |
| AVE | 0.4791 | 3.104 |
| STD | 0.0335 | 0.3266 |

Used

| | | |
|---|---|---|
| 1 | 0.444 | 2.43 |
| 2 | 0.402 | 2.612 |
| 3 | 0.347 | 2.582 |
| 4 | 0.428 | 2.636 |
| 5 | 0.403 | 2.82 |
| 6 | 0.425 | 3.073 |
| 7 | 0.457 | 2.793 |
| 8 | 0.423 | 3.05 |
| 9 | 0.443 | 2.625 |
| AVE | 0.4191 | 2.7356 |
| STD | 0.0326 | 0.2172 |

Fresh 3

| | | |
|---|---|---|
| 1 | 0.555 | 4.43 |
| 2 | 0.578 | 3.79 |
| 3 | 0.524 | 3.063 |
| 4 | 0.468 | 3.37 |
| 5 | 0.466 | 3.156 |
| 6 | 0.491 | 3.925 |
| 7 | 0.492 | 3.048 |
| 8 | 0.499 | 3.004 |
| 9 | 0.49 | 3.369 |
| AVE | 0.507 | 3.4616 |
| STD | 0.0382 | 0.4886 |

Middle

| | | |
|---|---|---|
| 1 | 0.44 | 3.039 |
| 2 | 0.435 | 2.541 |
| 3 | 0.424 | 2.97 |
| 4 | 0.457 | 3.208 |
| 5 | 0.443 | 2.885 |
| 6 | 0.466 | 2.973 |
| 7 | 0.496 | 3.321 |
| 8 | 0.481 | 3.196 |
| 9 | 0.454 | 3.094 |
| AVE | 0.4562 | 3.0252 |
| STD | 0.0231 | 0.2277 |

Used

| | | |
|---|---|---|
| 1 | 0.469 | 3.181 |
| 2 | 0.473 | 3.503 |
| 3 | 0.456 | 3.737 |
| 4 | 0.409 | 2.881 |
| 5 | 0.413 | 3.026 |
| 6 | 0.427 | 2.867 |
| 7 | 0.491 | 2.742 |
| 8 | 0.458 | 3.025 |
| 9 | 0.466 | 3.479 |
| AVE | 0.4513 | 3.1601 |
| STD | 0.0284 | 0.3404 |

TABLE 2B
Summary of average values for Rₐ and R_{z} from data of Table 2A

| Wafer sample | Rₐ [μm] | R_{z} [μm] |
|---|---|---|
| Fresh AVE | 0.5092 (0.0402 STD) | 3.357 (0.6395 STD) |
| Middle AVE | 0.4604 (0.0301 STD) | 3.019 (0.2522 STD) |
| Used AVE | 0.4283 (0.034 STD) | 2.902 (0.3392 STD) |
| Total AVE | 0.4680 (0.0479 STD) | 3.084 (0.4766 STD) |

### Example 8

From the 9-point measuring data shown in Table 2A and additional measurements close to the edges of the wafers to implement the tail effect, the total thickness variation (TTV) of the wafers with tail effect was calculated.

The average TTV values of the silicon wafers cut with coolant fluid of Example 1 were compared with the average TTV values measured for silicon wafers cut under the same conditions as described in Example 7, except that as coolant fluid Comparative Coolant A and Comparative Coolant B were used. Both comparative coolants did not contain an organic phosphorous containing acid or salt thereof and represented traditional commercial polyglycol-based coolant fluids.

As can be seen from Table 3, the TTV value (including the tail effect) for the silicon wafers cut with the coolant fluid of Example 1 is much lower than the TTV values for wafers cut in the presence of Comparative Coolant A and Comparative Coolant B.

TABLE 3
Comparison of TTV values of sliced silicon wafers

| | | TTV [μm]- |
|---|---|---|
| | Wire Bow [mm] | including tail effect |
| Example 1 Coolant | 6 | 37.78 |
| Comparative Coolant A | 7 | 53.29 |
| Comparative Coolant B | 6 | 57.06 |

### Example 9

The silicon wafer cutting performance using the fluids of Examples 4, and 5 were compared with Comparative Example 6.

Semi-square ingots of monocrystalline silicon of 125 mm length were sliced in a wire saw machine with Fixed Abrasive Diamond Wire (Meyer Burger DS271, supplied by BEAKERT) using the fluids of Example 4, Example 5, and Comparative Example 6 as coolant fluids. The table speed (cut rate) was 1 mm/minute, the wire speed was 14 m/s, the Pelgrim mode was 400 meters forward 395 meters back, and the wire pitch was 315 microns. The ingot was mounted using epoxy.

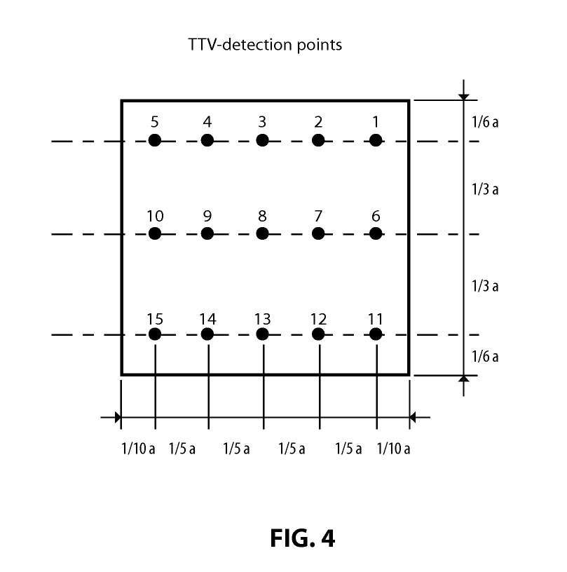

For the evaluation of the cut silicon wafers, a 15-point measurement was employed (see FIG. 4). As can be seen in Table 4, while the silicon cut with the fluids of Examples 4 and 5 show excellent TTV values and good machine workability, in the case of using the fluid of Comparative Example 6, the machine had a high torque and high wire bow, and the thickness throughout the wafer varied significantly, resulting in a comparatively very high TTV value.

TABLE 4
Results from cutting tests with fluids of
Examples 4, 5 and Comparative Example 6

| | Machine | Wafer | TTV* | Bow | |
|---|---|---|---|---|---|
| | Torque | thickness | (15-points) | Height | Wire |
| Solution | [Nm] | [μm] | [μm] | used/fresh | pairings |
| Example 4 | 85 | 183.7 | 10 | 3/3 | No |
| Example 5 | 93 | 186.3 | 9 | 4/4 | No |
| Comparative | 100 | 185 | >15* | 10/6 | Yes |
| Example 6 | | | | | |

*The TTV was very unstable, and varied significantly across the tested wafers.

It is noted that in contrast to Examples 4 and 5, the aqueous fluid of Comparative Example 6 did not contain a surfactant. As shown in Table 4, the cutting performance during the use of the coolant fluid of Comparative Example 6 resulted in a high torque and high wire bow, which had an effect on the machine usability and the quality of the wafers compared to Examples 4 and 5.

Although not entirely understood by its mechanism, the results indicate that a synergistic interaction between the organic phosphorous containing acid and the surfactant leads to a better cutting efficiency and improved wafer quality.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any sub combination. Further, references to values stated in ranges include each and every value within that range.

Without wishing to be bound by theory, while the mechanism of this interaction is not entirely understood, it is believed to be unique to aqueous fluids of the present disclosure.

It will be appreciated that not all of the features, components and/or activities described above in the general description in relation to embodiments of the present disclosure or the examples are required, that a portion of a specific feature, component and/or activity may not be required, and that one or more further features, components and/or activities may be required, added or performed in addition to those described. Still further, the orders in which activities are listed are not necessarily the order in which they are performed.

What is claimed is:

1. An aqueous coolant fluid for cutting or machining a substrate, comprising:
at least one organic phosphorous containing acid or salt thereof in an amount of 0.01 wt % to 10 wt % based on the total weight of the coolant fluid;
at least one polyol in an amount of at least 15 wt % based on the total weight of the coolant fluid; and
at least one surfactant,
wherein a weight ratio of the organic phosphorous containing acid to the at least one surfactant is from about 10:1 to about 1:10.

2. The aqueous coolant fluid of claim 1, wherein the at least one surfactant is present in an amount of 0.001 wt % to 10.0 wt % based on the total weight of the cooling fluid.

3. The aqueous coolant fluid of claim 1, wherein the organic phosphorous containing acid is selected from the group consisting of 2-Aminoethylphosphonic acid (AEP); 1-Hydroxy Ethylidene-1,1-Diphosphonic Acid (HEDP); Amino tris(methylene phosphonic acid) (ATMP); Ethylenediamine tetra(methylene phosphonic acid (EDTMP); Tetramethylenediamine tetra(methylene phosphonic acid (TDTMP); Hexamethylenediamine tetra(methylene phosphonic acid (HDTMP); Diethylenetriamine penta(methylene phosphonic acid (DTPMP); Phosphonobutane-tricarboxylic acid (PBTC); N-(phosphonomethyl)iminodiacetic acid (PMIDA); 2-carboxyethyl phosphonic acid (CEPA); and Amino-tris-(methylene-phosphonic acid (AMP).

4. The aqueous coolant fluid of claim 3, wherein the organic phosphorous containing acid comprises 1-Hydroxy Ethylidene-1,1-Diphosphonic Acid (HEDP).

5. The aqueous coolant fluid of claim 1, wherein a pH value of the coolant fluid is not greater than 7.

6. The aqueous coolant fluid of claim 1, wherein the ratio of the at least one organic phosphorous containing acid or salt thereof to the at least one surfactant is from about 10:1 to about 1:1.

7. The aqueous coolant fluid of claim 1, wherein the polyol is diethylene glycol, triethylene glycol or polyethylene glycol up to a molecular weight M_{w} of 500 g/mol.

8. The aqueous coolant fluid of claim 1, further comprising a defoamer in an amount from 0.001 to 0.1 wt % based on the total weight of the coolant fluid.

9. A liquid concentrate adaptable for dilution with a water-based diluent to obtain a coolant fluid, the liquid concentrate comprising:
at least one organic phosphorous containing acid or salt thereof in an amount of 0.02 wt % to 30 wt % based on the total weight of the liquid concentrate;
at least one polyol in an amount of 30 wt % to 90 wt % based on the total weight of the liquid concentrate; and
at least one surfactant,
wherein a weight ratio of the organic phosphorous containing acid to the at least one surfactant is from about 10:1 to about 1:10.

10. The liquid concentrate of claim 9, wherein the at least one surfactant is present in an amount of 0.002 wt % to 30 wt % based on the total weight of the liquid concentrate.

11. The liquid concentrate of claim 9, wherein the organic phosphorous containing acid is selected from the group consisting of 2-Aminoethylphosphonic acid (AEP); 1-Hydroxy Ethylidene-1,1-Diphosphonic Acid (HEDP); Amino tris(methylene phosphonic acid) (ATMP); Ethylenediamine tetra(methylene phosphonic acid (EDTMP); Tetramethylenediamine tetra(methylene phosphonic acid (TDTMP); Hexamethylenediamine tetra(methylene phosphonic acid (HDTMP); Diethylenetriamine penta(methylene phosphonic acid (DTPMP); Phosphonobutane-tricarboxylic acid (PBTC); N-(phosphonomethyl)iminodiacetic acid (PMIDA); 2-carboxyethyl phosphonic acid (CEPA); and Amino-tris-(methylene-phosphonic acid (AMP).

12. The liquid concentrate of claim 11, wherein the at least one organic phosphorous containing acid or salt thereof comprises 1-Hydroxy Ethylidene-1,1-Diphosphonic Acid (HEDP).

13. The liquid concentrate of claim 9, wherein a pH value of the liquid concentrate is not greater than 7.

14. The liquid concentrate of claim 9, wherein the polyol is diethylene glycol, triethylene glycol or polyethylene glycol up to a molecular weight M_{w} of 500 g/mol.

15. The liquid concentrate of claim 9, further comprising a defoamer in an amount of 0.002 to 0.2 wt % based on the total weight of the liquid concentrate.

16. The liquid concentrate of claim 9, wherein the ratio of the at least one organic phosphorous containing acid or salt thereof to the at least one surfactant is from about 10:1 to about 1:1.

17. A method of cutting a substrate, comprising
providing a coolant fluid containing an organic phosphorous containing acid compound or salt thereof in an amount of 0.1 to 10 wt %; at least one polyol in an amount of at least 15 wt %; and at least one surfactant in an amount of 0.01 to 10.0 wt % based on the total weight of the coolant fluid, wherein a pH value of the fluid is not higher than about 7; and
cutting the substrate with a saw.

18. The method of claim 17, wherein the cutting includes wire slicing a substrate with a fixed abrasive wire saw.

19. The method of claim 18, wherein the substrate comprises an ingot including a material selected from the group consisting of semiconductors, insulators, silicon, sapphire, a Group III-V material, and any combination thereof.

20. The method of claim 19, wherein a silicon wafer obtained after cutting the silicon ingot has a total thickness variation (TTV) with tail effect of not greater than 50 μm, an average surface roughness Rₐ of a not greater than 1.5 μm and an average surface roughness R_{z} not greater than 7 μm.
